(19) United States
(12) Patent Application Publication
(10) Pub. No.: US 2016/0137532 A1
(43) Pub. Date: May 19, 2016

(54) ION-EXCHANGE PURIFICATION METHOD AND APPARATUS

(71) Applicant: FILTERBOXX WATER AND ENVIRONMENTAL CORP., Calgary (CA)

(72) Inventors: Kevin SLOUGH, Calgary (CA); Amr ZAKY, Calgary (CA)

(21) Appl. No.: 14/941,042

(22) Filed: Nov. 13, 2015

Related U.S. Application Data
(60) Provisional application No. 62/079,863, filed on Nov. 14, 2014.

(51) Int. Cl. C02F 1/42

(52) U.S. Cl. CPC C02F 1/42; C02F 2209/40; C02F 2303/16; C02F 2001/425

(57) ABSTRACT

An ion-exchange water purification method and system. Feed water is exposed in countercurrent to active media in a vessel, resulting in treated water and spent media. The treated water flows upwards in the vessel and is recovered. The spent media flows to a regeneration zone of the vessel below the active media and is exposed to a regenerant in the regeneration zone, resulting in regenerated media and spent regenerant. The regenerated media flows to a point above the active media and from the point above the active media toward the active media while treated water flows upwards in countercurrent from the active media toward the regenerated media, rinsing the regenerated media and resulting in rinsed media and rinse water. The rinsed media flows to the active media and is combined with the active media.

### CROSS REFERENCE TO RELATED APPLICATIONS

This application claims the benefit of priority of U.S. Provisional Patent Application No. 62/079,863 filed Nov. 14, 2014, which is hereby incorporated by reference.

### FIELD

The present disclosure relates generally to purification of water. More particularly, the present disclosure relates to purification of water by ion exchange.

### BACKGROUND

Prior continuous ion-exchange processes include Higgin's loop variants, carousel-based systems, and fluidized bed systems.

Higgin's loop systems implement an incremental pulsing to perform batch-like processing. The incremental pulses utilize water to move the ion-exchange media in a vertical cylindrical loop. At various locations within the loop, the ion-exchange processes including resin exhaustion, resin regeneration, and resin rinsing are performed on essentially static beds of ion-exchange media. Each time the ion-exchange media is moved to another location to undergo the net process step in the loop, the processing operation needs to be interrupted, valves need to repositioned, and pulse water needs to be introduced into the system. Therefore, the Higgin's loop is a complex system process and requires a large footprint.

Carousel-type systems involve placing multiple vessels with multiple inlet and outlet nozzles around a central distributor. The distributor may rotate or the vessels may be placed on a rotating “turn-table” or both. As the distributor/turn-table rotates, the nozzles on the central distributor line up with corresponding nozzles on each vessel associated with a specific process step. In this way, as the distributor rotates each vessel sequentially runs through the processes of resin exhaustion, resin regeneration, and resin rinsing. Instead of the resin moving to a different location for each process step, the process is in effect brought to each vessel in sequence. As a result, carousel-type systems also tend to be large and complex.

Fluidized bed systems contact ion-exchange resin with the raw water to be treated concurrently in an upflow fluidized bed reactor. The slurry of resin and treated water is separated at the top of the reactor. The resin is directed to another column for regeneration and returned to the reactor while the treated water leaves the system. In order to maintain the minimum upward velocity to fluidize the resin bed while providing the required water/resin contact time for treatment, a large fluidized bed reactor height would be required. The height requirements impose limitations on the installation of fluidized bed ion-exchange reactors and the resulting high pumping heads result in increased energy costs. It also may be more difficult to obtain the equilibrium obtained in a fixed bed and may result in more leakage, thus requiring an additional polishing bed.

### SUMMARY

Herein disclosed is an ion-exchange purification method and apparatus. The method includes, and the apparatus facilitates, a continuous counter-current ion-exchange process in which purification of feed water, regeneration of ion-exchange media, and rinsing of regenerated media may all occur simultaneously within a single reactor vessel. As described above, previous systems, such as those using a Higgin's loop, a carousel, or a fluidized bed, suffer from drawbacks in terms of complexity and footprint size. It is therefore desirable to provide an improved ion-exchange purification method and apparatus which does not suffer from these drawbacks.

It is an object of the present disclosure to obviate or mitigate at least one disadvantage of previous ion-exchange purification systems. The method and apparatus herein disclosed may be particularly applicable to water softening applications, and may provide capital and operating cost efficiencies compared with both conventional fixed bed ion-exchange processes and conventional continuous ion-exchange processes. The method and apparatus herein disclosed may facilitate application without the need for significant instrumentation and may be adapted to allow for real-time process optimization.

The apparatus includes a vessel for receiving a bed of ion-exchange material. When applying the vessel to practice the method, feed water to be purified is introduced into the vessel below the ion-exchange material and flows upward in countercurrent through the bed of active ion-exchange material, which is continually flowing downwards in a moving bed. During upward flow of the feed water, the feed water is purified and recovered (e.g. at a weir at the top of the vessel, etc.). Spent ion-exchange material settles downward in the vessel and passes through a flow restrictor (e.g. a tortuous path, a narrow passage, etc.) to a lower portion of the vessel where regenerant solution is introduced into the vessel to regenerate the ion-exchange material. The majority of any regenerant solution which is not consumed during regeneration is recovered at the lower portion of the vessel below the flow restrictor. The regenerated ion-exchange material is pumped upwards and into a separator above the bed of active ion-exchange material. The separator is continuously filled by upflowing treated water which enters the separator. Regenerated ion-exchange material flows downward from the separator in countercurrent with the upflowing treated water, rinsing the ion-exchange material as it flows downward back into the bed to contact upflowing feed water and repeat the cycle.

In a first aspect, the present disclosure provides an ion-exchange water purification method and system. Feed water is exposed in countercurrent to active media in a vessel, resulting in treated water and spent media. The treated water flows upwards in the vessel and is recovered. The spent media flows to a regeneration zone of the vessel below the active media and is exposed to a regenerant in the regeneration zone, resulting in regenerated media and spent regenerant. The regenerated media flows to a point above the active media and from the point above the active media toward the active media while treated water flows upwards in countercurrent from the active media toward the regenerated media, rinsing the regenerated media and resulting in rinsed media and rinse water. The rinsed media flows to the active media and is combined with the active media.

In a further aspect, the present disclosure provides an ion-exchange water purification method comprising: exposing feed water to active media in a vessel, resulting in treated water and spent media; flowing the treated water upwards in the vessel and recovering the treated water; flowing the spent media to a regeneration zone of the vessel below the active media; exposing the spent media to a regenerant in the regeneration zone, resulting in regenerated media and spent regenerant; flowing the regenerated media to a point above the active media; flowing the regenerated media from the point above the active media toward the active media and flowing the treated water in countercurrent from the active media toward the regenerated media, rinsing the regenerated media and resulting in rinsed media and rinse water; flowing the rinsed media to the active media; and removing the spent regenerant.

In some embodiments, exposing the feed water to the active media comprises providing the feed water into the vessel at a point below the active media and flowing the feed water upwards in countercurrent through the active media as the spent media flows downwards towards the regeneration zone.

In some embodiments, the point above the active media comprises a separator partially fluidly isolated from the active media and in fluid communication with the active media along a conduit for containing diffusion of the rinsed media and the rinse water into the treated water. In some embodiments, flowing the treated water in countercurrent from the active media toward the regenerated media comprises flowing the treated water upward through the conduit into the separator; and flowing the regenerated media from the point above the active media toward the active media comprises flowing the regenerated media downward through the conduit from the separator in countercurrent with the treated water flowing upward into the separator for rinsing the regenerated media and resulting in the rinsed media.

In some embodiments, removing the spent regenerant comprises removing the spent regenerant from the regeneration zone.

In some embodiments, the method includes controlling fluid flow between the active media and the regeneration zone for facilitating exposing the feed water to the active media.

In some embodiments, the method includes controlling fluid flow between the regeneration zone and the point above the active media for facilitating exposing the spent media to the regenerant.

In some embodiments, flowing the spent media to the regeneration zone comprises: flowing the spent media to the a spent media zone located above the regeneration zone; and flowing the spent media from the spent media zone to the regeneration zone. Fluid flow between the spent media zone and the regeneration zone is restricted to mitigate diffusion of the regenerant from the regeneration zone to the active media.

In some embodiments, flowing the regenerated media to the point above the active media comprises: flowing the regenerated media from the regeneration zone to a spent regenerant recovery zone of the vessel below the regeneration zone; and flowing the regenerated media from the spent regenerant recovery zone to the point above the active media. In some embodiments, removing the spent regenerant comprises removing the spent regenerant from the spent regenerant recovery zone. In some embodiments, the method includes controlling fluid flow between the regeneration zone and the spent regenerant recovery zone for facilitating exposing the spent media to the regenerant.

In some embodiments, exposing the spent media to the regenerant comprises agitating the spent media, the regenerant, the regenerated media, and the spent regenerant in the regeneration zone. In some embodiments, agitating the spent media, the regenerant, the regenerated media, and the spent regenerant comprises providing a crosscurrent within the regeneration zone. In some embodiments, agitating the spent media, the regenerant, the regenerated media, and the spent regenerant comprises mechanically stirring the spent media, the regenerant, the regenerated media, and the spent regenerant in the regeneration zone.

In some embodiments, exposing the feed water to the active media in the vessel; flowing the treated water upwards in the vessel and recovering the treated water; flowing the spent media to the regeneration zone of the vessel below the active media; exposing the spent media to the regenerant in the regeneration zone; flowing the regenerated media to the point above the active media; flowing the regenerated media from the point above the active media toward the active media and flowing the treated water in countercurrent from the active media toward the regenerated media; flowing the rinsed media to the active media; and removing the spent regenerant; are performed simultaneously.

In some embodiments, a media exhaustion phase comprises: exposing the feed water to the active media in the vessel; flowing the treated water upwards in the vessel and recovering the treated water; flowing the spent media to the regeneration zone of the vessel below the active media; flowing the spent media to the point above the active media; and flowing the spent media from the point above the active media toward the active media and flowing the treated water in countercurrent from the active media toward the spent media. A dynamic operation phase comprises: exposing the feed water to the active media in the vessel; flowing the treated water upwards in the vessel and recovering the treated water; flowing the spent media to the regeneration zone of the vessel below the active media; exposing the spent media to the regenerant in the regeneration zone; flowing the regenerated media to the point above the active media; flowing the regenerated media from the point above the active media toward the active media and flowing the treated water in countercurrent from the active media toward the regenerated media; flowing the rinsed media to the active media; and removing the spent regenerant. No regenerant is added to the regeneration zone during the exhaustion phase. The media exhaustion phase is alternated with the dynamic operation phase.

In a further aspect, the present disclosure provides an ion-exchange water purification vessel comprising: a body; a treatment zone defined within the body for receiving an active media; a feed water inlet for providing feed water to the treatment zone and exposing the feed water to the active media, resulting in treated water and spent media; a regeneration zone defined within the body below the treatment zone for receiving the spent media; a regenerant inlet for providing regenerant to the regeneration zone and exposing the spent media to a regenerant, resulting in regenerated media and spent regenerant; a regeneration zone barrier positioned between the treatment zone and the regeneration zone for restricting fluid flow between the treatment zone and the regeneration zone; and a separator above the treatment zone for exposing the regenerated media to the treated water to rinse the regenerated media, resulting in rinsed media and rinse water. The separator is in fluid communication with the regeneration zone for receiving the regenerated media from the regeneration zone. The separator is in fluid communication with the treatment zone for receiving purified fluid from the treatment zone. The separator is in fluid communication with the treatment zone for providing the rinsed media to the treatment zone for adding to the active media.

In some embodiments, the feed water inlet comprises a distributor positioned below the treatment zone for providing the feed water to the treatment zone in countercurrent to a downward flowing moving bed of active media. In some embodiments, the vessel includes a spent regenerant outlet intermediate the feed water inlet and a bottom end of the vessel. In some embodiments, the separator is in fluid communication with the regeneration zone through a regenerated media outlet proximate the bottom end of the vessel, and the spent regenerant outlet is positioned intermediate the distributor and the regenerated media outlet. In some embodiments, the vessel includes a spent media barrier positioned in the regeneration zone above the regenerated media outlet for restricting flow of spent media to the spent media outlet to prolong the residence time of the spent media in the regeneration zone.

In some embodiments, the separator is in fluid communication with the treatment zone through a conduit extending downward towards the treatment zone for confining the volume within which the regenerated media is exposed to the treated water and mitigating diffusion of the rinse water and of any residual regenerant mixed with the rinse water into the treatment zone.

In some embodiments, the separator comprises a spent regeneration fluid separation zone in fluid communication with a regenerated media rinsing zone; the separator is in fluid communication with the regeneration zone at the spent regeneration fluid separation zone; and the separator is in fluid communication with the treatment zone at the regenerated media rinsing zone.

In some embodiments, the regeneration zone barrier comprises a first plate and a second plate below the first plate; the first plate and the second plate define a spent media zone intermediate the first plate and the second plate, and the spent media zone is intermediate the treatment zone and the regeneration zone; and fluid flow between the spent media zone and the regeneration zone is restricted to mitigate diffusion of the regenerant from the regeneration zone to the active media. In some embodiments, the treatment zone is in fluid communication with the regeneration zone through in the first and second plates for providing a fluid flow path that passes proximate a center of the body and proximate an inside surface of the body. In some embodiments, the first plate slopes downward toward an aperture in the plate along the fluid flow path. In some embodiments, the second plate slopes downward toward an aperture in the plate along the fluid flow path.

In some embodiments, the vessel includes a spent regenerant recovery zone barrier below the regeneration zone, the spent regenerant recovery zone barrier defining and separating the regeneration zone from a spent regenerant recovery zone; and a spent regenerant outlet located in the spent regenerant recovery zone. In some embodiments, the spent regenerant recovery zone barrier comprises a plate having an aperture defined therein for defining a fluid flow path between the regeneration zone and the spent regenerant recovery zone, the plate downwardly tapering towards the aperture in the plate.

In some embodiments, the regeneration zone barrier comprises a plate having an aperture defined therein for defining a fluid flow path between the treatment zone and the regeneration zone, the plate downwardly tapering towards the aperture in the plate.

In some embodiments, the vessel includes a mechanical agitator extending into the regeneration zone for agitating fluids within the regeneration zone.

In some embodiments, the vessel includes a hydraulic circulator for providing a cross-current in fluids within the regeneration zone.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached figures, in which features sharing reference numerals with a common final two digits correspond to similar features across multiple features (e.g. the body 12, 112, 212, 312, etc.).

FIG. 1 is a cross-sectional elevation schematic of a water purification apparatus in operation;

FIG. 2 is a cross-sectional elevation schematic of a water purification apparatus;

FIG. 3 is the water purification apparatus of FIG. 2 in operation;

FIG. 4 is a cross-sectional elevation schematic of a water purification apparatus in operation;

FIG. 5 is a cross-sectional elevation schematic of a water purification apparatus in operation;

FIG. 6 is a baseline plot of hardness removal efficiency from an experiment using a bench-scale pilot test model having a general design as shown in FIG. 1;

FIG. 7 is a baseline plot of treated water hardness from the experiment;

FIG. 8 is a post-regeneration plot of hardness removal efficiency from the experiment;

FIG. 9 is a post-regeneration plot of treated water hardness from the experiment;

FIG. 10 is a plot of hardness removal efficiency from Trial 1 of the experiment;

FIG. 11 is a plot of treated water hardness from Trial 1 of the experiment;

FIG. 12 is a plot of hardness removal efficiency from Trial 2 of the experiment;

FIG. 13 is a plot of treated water hardness from Trial 2 of the experiment;

FIG. 14 is a plot of the net retained hardness for Trials 1 and 2 from the experiment;

FIG. 15 is a plot of the cumulative net retained hardness for Trials 1 and 2 from the experiment;

FIG. 16 is a plot of hardness removal efficiency from a pilot-scale experiment showing hardness removal efficiency before and after regenerant is added using the apparatus of FIG. 5; and

FIG. 17 is a plot of retained system hardness from the pilot-scale experiment showing constant retained hardness after addition of regenerant to the apparatus.

### DETAILED DESCRIPTION

Generally, the present disclosure provides a method and apparatus for purification of water by ion exchange. Results of a small bench-scale pilot test and of a larger pilot test are disclosed. The method includes, and the apparatus facilitates, application of a bed of ion-exchange media which is continuously flowing downward in a vessel (also termed a “moving bed” or “dynamic bed” of ion-exchange media) until pumped back to the top of the vessel. Feed water flows into the vessel at a point below active ion-exchange media in the moving bed. The moving bed continuously flows downward in the vessel in countercurrent to the feed water, purifying the feed water. Treated water is recovered above the moving bed. Spent ion-exchange media flows downward below the point at which the feed water is introduced.

The method and vessel disclosed herein may provide capital and operating costs savings compared to traditional ion-exchange systems, such as Higgin's loop, semi-continuous Higgins-loop, fluidized bed, and carousel-based systems due to a smaller footprint, reduced chemical usage, and reduced rinse water waste. Bench and pilot scale tests have been completed and at full scale, the method and vessel are expected to be particularly suitable for large-scale softening, hardness removal, and brackish water desalting.

Vessel

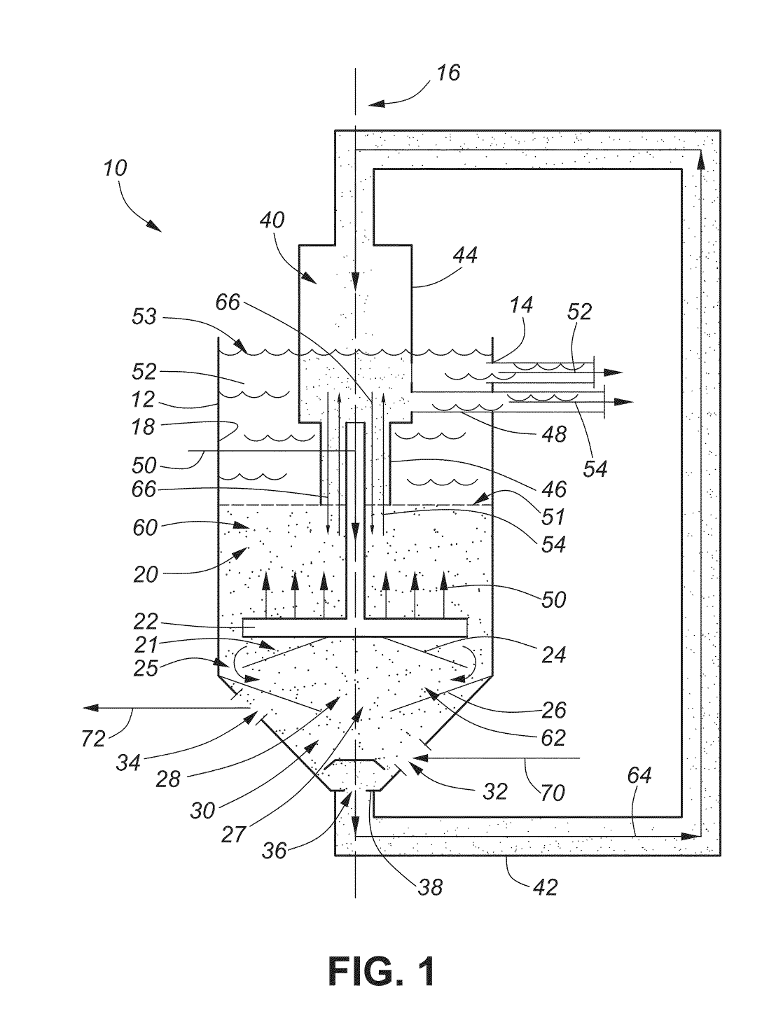

FIG. 1 shows a cross-sectional elevation view of a water purification vessel 10 in operation. The vessel 10 includes a body 12 for receiving ion-exchange media (e.g. cation exchange resin, anion exchange resin, etc.) and feed water. The body 12 defines a treatment zone 20 above a regeneration zone 30 and a media wash zone 40 above the treatment zone 20.

The treatment zone 20 includes a feed water distributor 22 for providing feed water into the treatment zone 20. After passing through active ion-exchange media in the treatment zone 20, treated water flows out of the body 12 through a treated water outlet 14 above the treatment zone 20.

The treatment zone 20 and the regeneration zone 30 are separated by a regeneration zone barrier 21 which provides incomplete fluidic isolation between the treatment zone 20 and the regeneration zone 30. The incomplete fluidic isolation provided by the regeneration zone barrier 21 mitigates or prevents regenerant in the regeneration zone 30 from flowing upwards against a downward current of a moving bed of ion-exchange material and into the treatment zone 20, where the regenerant would inhibit purification of the feed water by active ion exchange media.

The regeneration zone barrier 21 includes an upper plate 24 and a lower plate 26 (e.g. in the shape of a frustocone for a cylindrical body 12, etc.). The upper plate 24 is downwardly tapering from a center 16 of a cross-sectional area of the body 12 towards an inside surface 18 of the body 12. The center 16 is defined along a vertical axis of the body 12, and at the centre of a horizontal cross-sectional area of the body 12. The upper plate 24 is separated from the inside surface 18 of the body 12 by a space 25 for spent ion-exchange media to flow down the slope of the upper plate 24 and through the space 25 into a spent media zone 28 defined between the upper plate 24 and the lower plates 26. The spent media zone 28 is defined within the regeneration zone barrier 21 between the upper plate 24 and the lower plate 26. The spent media zone 28 proves additional incomplete fluidic isolation between the treatment zone 20 and the regeneration zone 30. The lower plate 26 is downwardly tapering from the inside surface 18 of the body 12 toward the center 16 of the cross-sectional area of the body 12 and defines a passage 27 between the spent media zone 28 and the regeneration zone 30. The passage 27 is coextensive with the center 16 of the body 12 and is located at a low point of the downward taper of the lower plate 26. By the locations of the passage 27 and the space 25, a fluid flow path between the treatment zone 20 and the regeneration zone 30 that passes proximate the center 16 of the body 12 and proximate the inside surface 18 of the body 12.

The regeneration zone 30 includes a regenerant solution inlet 32 and a regenerant solution outlet 34. The regenerant solution inlet 32 is located at a relatively low portion of the regeneration zone 30 to provide regenerant solution to the regeneration zone 30 in upward countercurrent to spent media the in the regeneration zone 30. The location of the regenerant solution inlet 32 also mitigates flow of the regenerant solution past the regeneration zone barrier 21 and into treatment zone 20, including mitigating flow of the regenerant solution into the spent media zone 28. The regenerant solution outlet 34 may be positioned above and towards the body 12 relative to the passage 27 to mitigate backflow of regenerant solution into the spent media zone 28. A regenerated media outlet 36 is located at a lower portion of the regeneration zone 30 and is in communication with the media wash zone 40 through a regenerated media conduit 42. The regeneration zone 30 may include a separator plate 38 positioned between the passage 27 and the regenerated media outlet 36 to mitigate flow of spent media to the media wash zone 40 prior to sufficient exposure of the media to regenerant. The separator plate 38 functions as a spent media barrier and facilitates exposure of spent media to regenerant in the regeneration zone.

The media wash zone 40 is generally fluidly isolated from the treatment zone 20 and the interior of the body 12 above the treatment zone 20 except through a countercurrent rinsing conduit 46. The countercurrent rinsing conduit 46 provides a fluid flow passage for fluid communication between the media wash zone 40 and the treatment zone 20. The countercurrent rinsing conduit 46 may be positioned proximate the center 16 of the body 12 as shown in FIG. 1. A separator 44 isolates the media wash zone 40 from the regeneration zone 30, with the media wash zone 40 being defined within the separator 44. The media wash zone 40 is in fluid communication with the treatment zone 20 through the countercurrent rinsing conduit 46 for facilitating upflow of treated water from the treatment zone 20 and countercurrent downflow of media from the media wash zone 40. A rinse water outlet 48 provides a fluid flow passage from the media wash zone 40 to the outside of the vessel 12.

Operation

In operation, raw feed water 50 to be treated is introduced into the vessel 12 at the base of an active media bed 60 via the water distributor 22. The feed water 50 flows upwards through the active media bed 60. As the feed water 50 flows through and contacts the active media bed 60, target ions are removed from the feed water 50 and sorbed onto the ion-exchange media of the media bed 60, resulting in treated water 52 and spent media 62.

The treated water 52 flows upwards out of the active media bed 60 and to the treated water outlet 14 proximate a top end of the vessel 12. The amount of ion-exchange media provided into the body 12 will result in a media surface 51 at which the active media bed 60 rests. The treated water 52 in the treatment zone 40 similarly has a treated water surface 53 above the treated water outlet 14. Any suitable approach to recovering the treated water 52 based on the treated water surface 53 may be applied (e.g. overflowing from the vessel 10 at a treated water weir, etc.). The rinse water 54, the regenerated media 64, the rinsed media 66, and any residual spent regeneration fluid 72 in the media wash zone 40 have a similar top surface to the treated water surface 53. The rinse water outlet 48 communicates with the media was zone 40 below the treated water surface 53.

The spent media 62 flows downward from the treatment zone 20 through the space 25 around the upper plate 24, and into the spent media zone 28. From the spent media zone 28, the spent media 62 flows through the passage 27 defined in the lower plate 26 proximate the center 16, and into the regeneration zone 30.

Regenerant solution 70 flows into a lower portion of the regeneration zone 30 through the regenerant inlet 32. The regenerant solution 70 is exposed to the spent media 62 in the regeneration zone 30, resulting in regenerated media 64 and spent regenerant solution 72. The spent regenerant solution 72 flows out of the vessel 12 at the regeneration outlet 34, which may be positioned at an upper portion of the regeneration zone 30 to facilitate upward flow of the spent regenerant solution 72 in countercurrent to the regenerated media 64. The regenerated media 64 flows out of the regenerated media outlet 36 and flows to the media wash zone 40 via the media conduit 42. An air pump (not shown) may be used to provide an effective resin flow rate to the regenerated media 64.

The regenerated media 64 flows through the media conduit 42 into the media wash zone 40, through the countercurrent rinsing conduit 46, and into the treatment zone 20, exposing the regenerated media 64 to the treated water 52 in countercurrent, resulting in rinsed media 66 and rinse water 54. The countercurrent rinsing conduit 46 provides a pathway of relatively low surface area compared with the body 12 as a whole, which partially isolates the treated water 52 from the rinse water 54. Partial isolation of the treated water 52 from the rinse water 54 and the regenerated media 64, which may include regenerant, may improve the backwash efficiency to the regenerated media 64, thus improving the efficiency of the overall process and the quality of the treated water 52.

The rinse water 54 flows out of the separator 44 and out of the vessel 12 through the rinse water outlet 48 proximate a top end of the separator 44 and below the treated water surface 53. The rinsed media 66 flows to the active media bed 60 and is combined with the active media bed 60, completing the continuous process through the vessel 10. Where the countercurrent rinsing conduit 46 is positioned proximate the center of the cross-sectional area of the body 12 (as shown in FIG. 1), the rinsed media 66 will flow to the active media bed 60 proximate the center 16 of the body 12, which may facilitate even distribution of the rinsed media 66 across the active media bed 60.

The vessel 10 may be operated continuously in a dynamic operation mode. In the dynamic operation mode, the raw feed water 50 is introduced into the treatment zone 20, the treated water 52 is recovered, the rinse water 54 is recovered, the spent media 62 flows to the regeneration zone 30, the regenerated media 64 flows from the regeneration zone 30 to the media wash zone 40, the rinsed media 64 flows to the active media bed 60, the regeneration fluid 70 is provided to the regeneration zone 30, and the spent regeneration fluid 72 is recovered, simultaneously.

The vessel 10 may be operated in an exhaustion mode and the dynamic operation mode. The exhaustion mode includes the same flow patterns as the dynamic operation mode, but no regeneration fluid 70 is added to the system. In the exhaustion mode, the raw feed water 50 is introduced into the treatment zone 20, the treated water 52 is recovered, the rinse water 54 is recovered, the spent media 62 flows to the regeneration zone 30, the spent media 62 flows from the regeneration zone 30 to the media wash zone 40, and the spent media 62 flows to the active media bed 60, simultaneously. During operation in the exhaustion mode, the spent media 62 may include media which is not entirely exhausted. The exhaustion mode may be operated until a selected lower threshold of hardness removal efficiency of the spent media 62 is observed. When the selected lower threshold of hardness removal efficiency is observed, the vessel 10 may be operated in the dynamic operation mode to regenerate the spent media 62 and resume dynamic operation mode.

The exhaustion mode may precede the dynamic operation mode until the lower threshold of hardness removal efficiency is observed, and the dynamic operation mode may continue with no further application of the exhaustion mode. Alternatively, the exhaustion mode and the dynamic operation mode may be alternated to control the hardness removal efficiency and to control use and recovery of regenerant.

Vessel Design

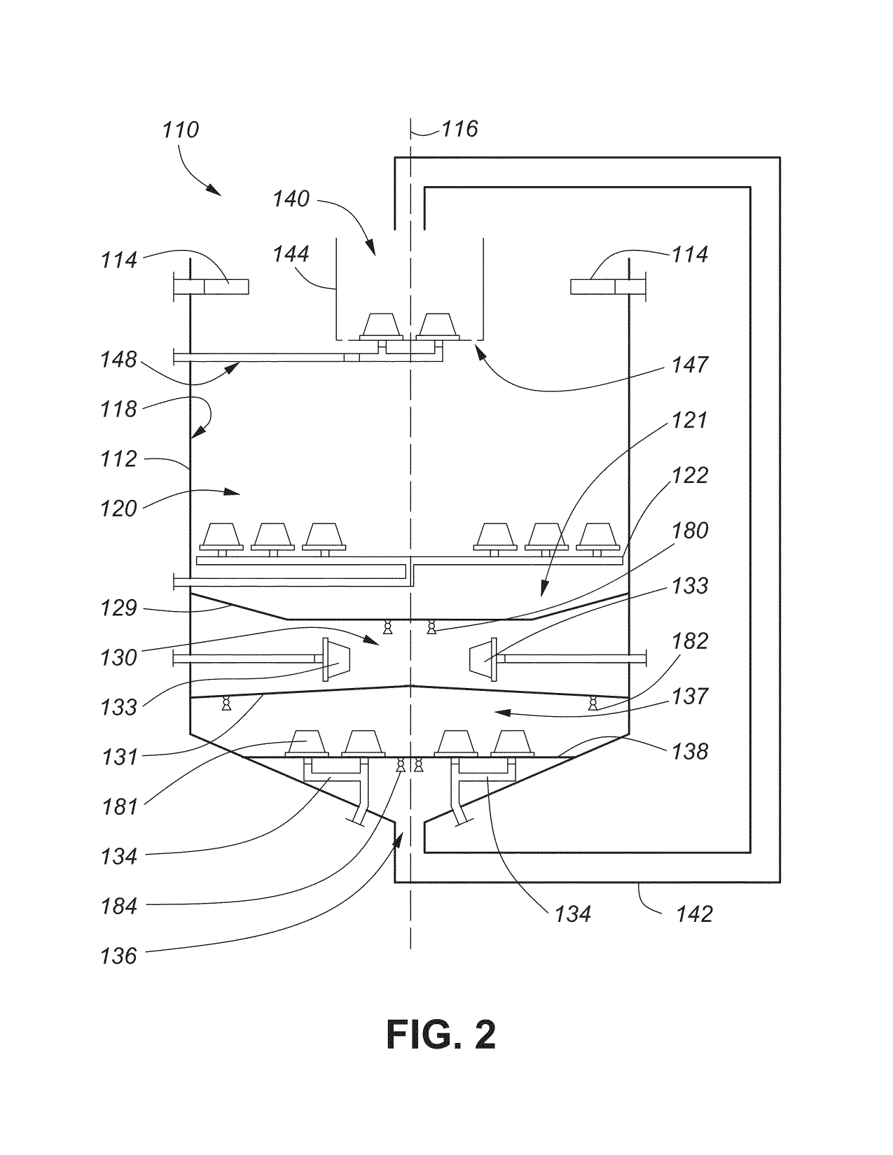

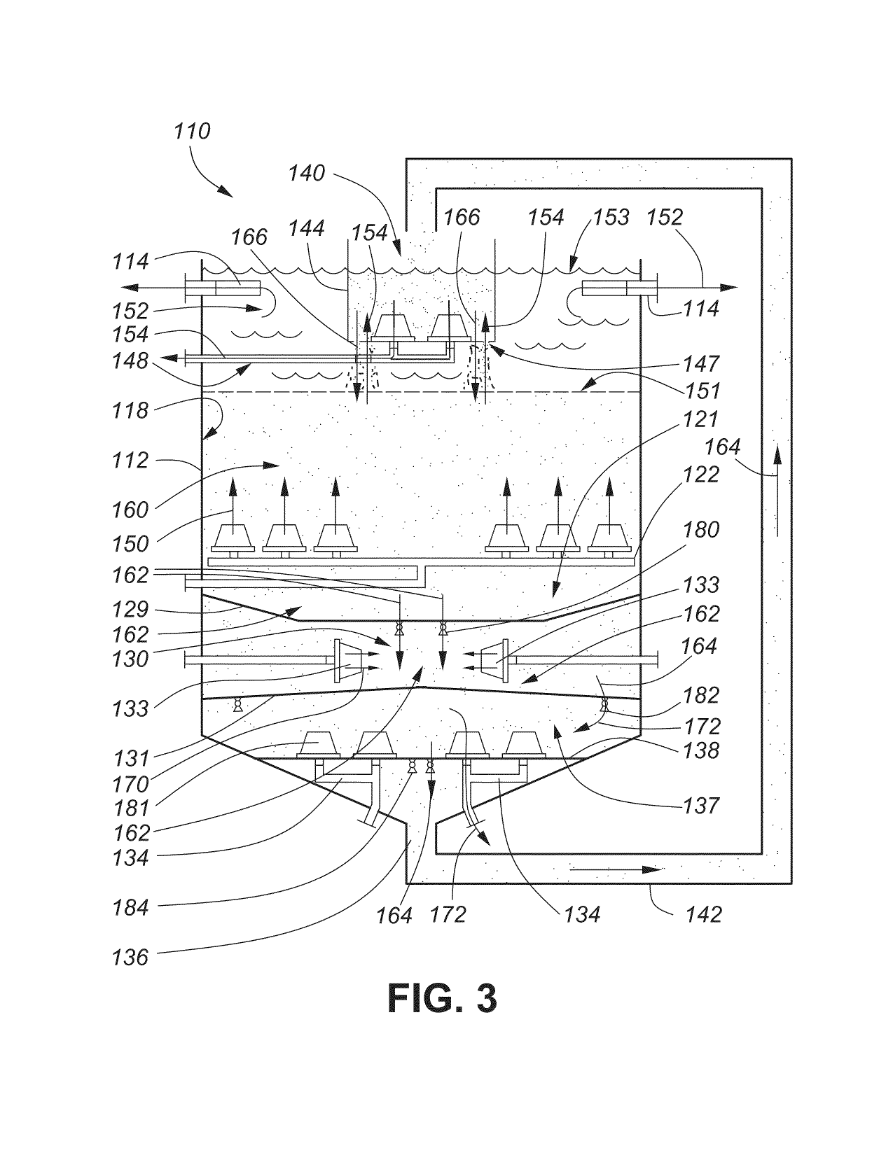

FIGS. 2 and 3 show a vessel 110 at rest and in operation. The vessel 110 includes a spent regenerant recovery zone 137 which is partially fluidly isolated from the regeneration zone 130 by a spent regenerant recovery zone barrier 131. In contrast to the vessel 10, the vessel 110 provides for regeneration of spent media 162 and recovery of spent regeneration fluid 172 in separate zones of the vessel 110. The spent media 162 is regenerated by the regeneration fluid 170 in the regeneration zone 130. The resulting spent regeneration fluid 172 is recovered in the spent regenerant recovery zone 137.

In the vessel 110, the regeneration zone barrier 121 between the treatment zone 120 and the regeneration zone 130 includes a single plate 129, in contrast with the upper plate 24 and the lower plate 26 of the regeneration zone barrier 21. The plate 129 includes a pair of apertures 180 proximate the center 116. The apertures 180 may include valves for controlling flow of the spent media 162 into the regeneration zone 130. A pair of regeneration fluid distributors 133 provides the regeneration fluid 170 to the regeneration zone 130.

The regeneration zone 130 is defined between the regeneration zone barrier 121 on an upper end of the regeneration zone 130 and by the spent regenerant recovery zone barrier 131 on a lower end of the regeneration zone 130. The spent regenerant recovery zone 137 are below the spent regenerant recovery zone barrier 131. Four of the spent regeneration fluid outlets 134 are located in the spent regenerant recovery zone 137. Since the spent regenerant recovery zone 137 is below the regeneration zone 130, the spent regeneration fluid outlet 134 is below the regeneration fluid distributors 133. The relative locations of the spent regeneration fluid outlet 134 and the regeneration fluid distributors 133 are in contrast with the locations of the regeneration fluid inlet 32 and the spent regeneration fluid outlet 34 in the vessel 10.

The separator plate 138 extends to the inside surface 118 and includes two apertures 184 for controlling flow of the regenerated media 164 into the regenerated media outlet 136. The majority of the spent regenerant solution 172 is recovered at the spent regeneration fluid outlet 134 in the spent regenerant recovery zone 137. The spent regeneration fluid outlet 134 includes a cover 181 for mitigating or preventing entry of the regenerated media 164 into the regeneration fluid outlet 134. A portion of the spent regeneration fluid 172 carrying the regenerated media 164 flows downward through the apertures 184 into and through the regenerated media outlet 136.

The separator 144 includes a rinsing outlet 147 in place of the countercurrent rinsing conduit 46. The rinsing outlet 147 results in more rapid diffusion of the regenerated media 164 into the treated water 152 relative to the diffusion which would result from the countercurrent rinsing conduit 46, all other factors being equal. Use of the rinsing outlet 147 rather than the countercurrent rinsing conduit 46 to rinse the regenerated resin with the treated water 152 may result in the presence of more of the spent regenerant solution 172 in the treated water 152 compared with the vessel 10, but may also provide the benefit of allowing the body 112 to be have a shorter profile than the body 12, all other factors being equal.

Treated water 152 which flows upward into the separator 144 rinses the regenerated media 164, resulting in the rinsed media 166 and the rinse water 154. The rinse water 154 is recovered separately from the treated water 152 using the rinse water outlet 148 located in the separator 144.

During operation of the vessel 110, the apertures 180 may be closed and opened to control residence time of the feed water 150, the active media making up the active media bed 160, and the spent media 162 in the treatment zone 120. The treated water 152 may continue to be recovered at the treated water outlet 114 while the apertures 180 are closed. Closing the apertures 180 facilitates greater residence time in the treatment zone 120 to allow the active media bed 160 more time to treat the feed water 150.

During operation of the vessel 110, the apertures 182 may be closed and opened to control residence time of the spent media 162, the regenerated media 164, the regeneration fluid 170, and the spent regeneration fluid 172, in the regeneration zone 130. Closing the apertures 182 facilitates greater residence time in the treatment zone 130 to allow the regeneration fluid 170 more time to regenerate the spent media 162.

During operation of the vessel 110, the apertures 184 may be closed and opened to allow the regenerated resin 164 to accumulate in the spent regeneration fluid recovery zone 137. Closing and opening the apertures 184 may provide control over flow of the regenerated resin 164 through the vessel 110 while maintaining flow of the feed water 150, the treated water 152, and the rinse water 154. Closing and opening the apertures 184 may be used in combination with pulsing an air pump or other source of negative pressure used to flow the regenerated media 164 along the regenerated media conduit 142.

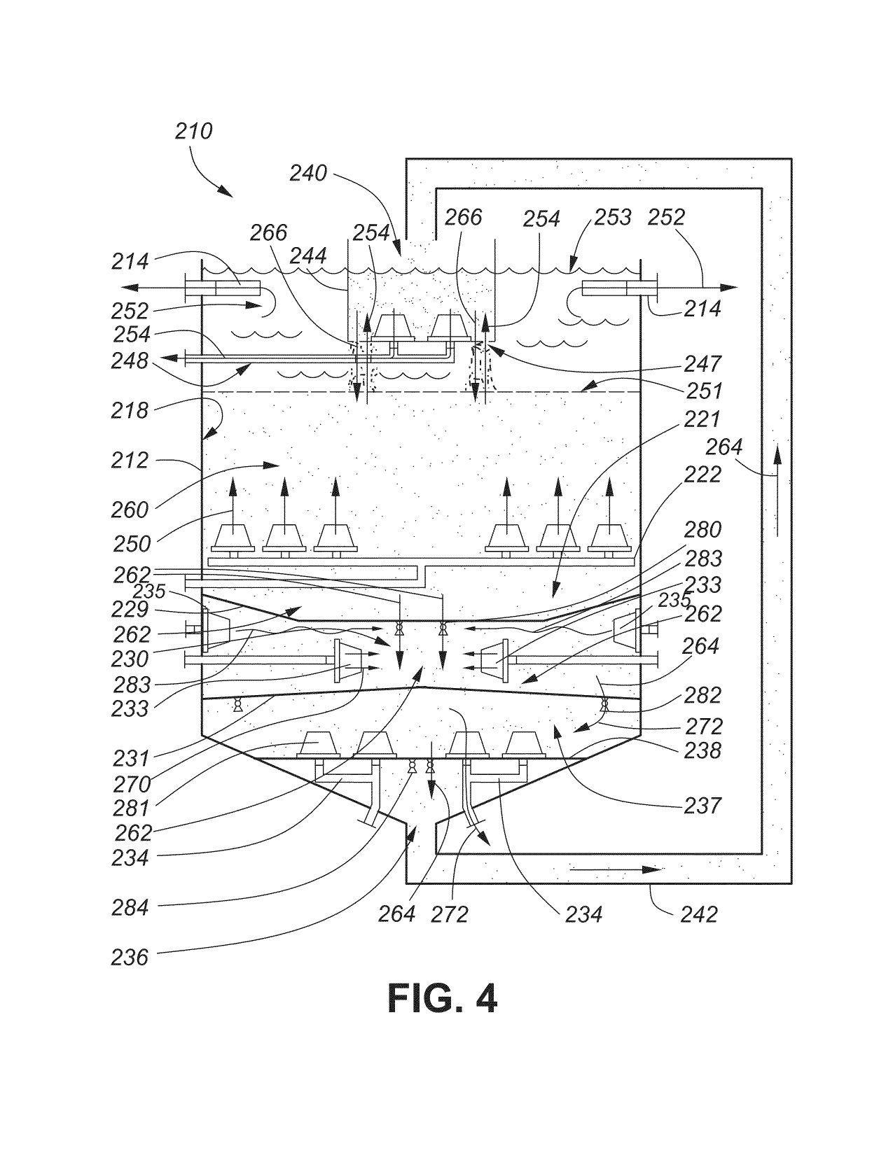

FIG. 4 is a vessel 210 including a mixing distributor 235. The mixing distributor 235 provides a cross-current circulation 283 to the spent media 262, regenerated media 264, regeneration fluid 270, and the spent regeneration fluid 272 present in the regeneration zone 230. The cross-current circulation 283 agitates the media and fluids present in the generation zone 230 and increases exposure of the spent media 262 to the regeneration fluid 270, facilitating regeneration to a target equilibrium point at a greater rate. Closing the apertures 282 may be used in addition to providing the cross-current circulation 283 to further increase exposure of the spent media 262 to the regeneration fluid 270. A pair of mixing distributors 235 are shown, but a single mixing distributor 235 could also be applied.

A mechanical stirring device or agitator could similarly provide a cross-current or other agitation of the contents of the regeneration zone to increase exposure of the spent media 262 to the regeneration fluid 270 in place of the mixing distributor 235. The cross-current may be substantially perpendicular to, tangential to, or otherwise crossing the downward flow of the spent media 262.

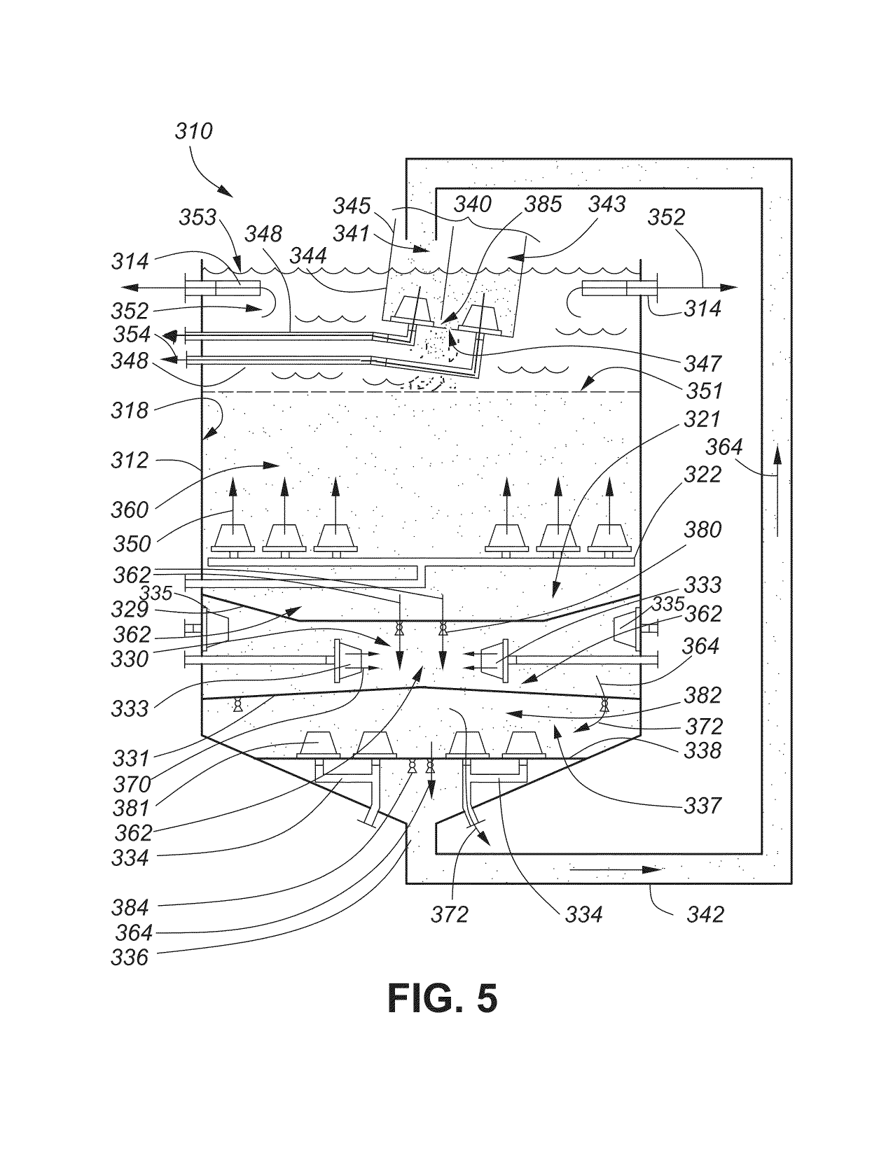

FIG. 5 is a vessel 310 including a two-stage separator 345. The two-stage separator 345 defines a separation zone 340 which includes a spent regeneration fluid separation zone 341 partially fluidly isolated from a regenerated media rinsing zone 343.

The two-stage separator 345 allows rinsing of the generated media 364 separately from recovery of the rinse water 354.

The spent regeneration fluid separation zone 341 is in fluid communication with the regenerated media rinsing zone 343 through an aperture 385. The aperture 385 is located at a lower end of the two-stage separator 345 to allow the regenerated media 364, which is flowing downwards, to flow into the regenerated media rinsing zone 343 preferentially to the spent regenerant solution 372, which is recovered at the rinse water outlet 348 both in the regeneration fluid separation zone 341 and the regenerated media rinsing zone 343. The two-stage separator 345 is angled to facilitate downward flow of the regenerated media 164 within the spent regeneration fluid separation zone 341 toward the aperture 385.

The rinsing outlet 347 is located in the regenerated media rinsing zone 343 to allow the regenerated media 364 to flow downwards into the treated water 352, while the treated water 352 flows upwards into the regenerated media rinsing zone 343 through the rinsing outlet 347, rinsing the regenerated media 364, which rejoins the active media bed 360. The rinse water 354 is recovered at the rinse water outlet 348 in the regenerated media rinsing zone 343.

### Example I

A vessel similar having a general design as shown in FIG. 1 was used in a small bench-scale pilot test of the dynamic bed ion-exchange method and vessel for softening tap water with additional added hardness using a strong acid cation-exchange resin as the ion-exchange media. The strong acid cation-exchange resin was operated on a sodium regeneration cycle. This pilot test provided an operational proof-of-concept of the dynamic bed ion-exchange system prior to moving to larger-scale pilot tests.

The initial bench-scale pilot test validates the basic design concept, which can be optimized for commercialization. The physical limitations of the bench-scale vessel preclude commercial development based on the vessel. A vessel/reactor with a design flow rate of 5 liters/min will allow for more variation of operating parameters. In addition, several different ion-exchange resins will be tested as part of the next stage of development to determine if any optimization of the system based on resin characteristics may be possible. Once the vessel design is optimized for sodium form, experimental work on the use of strong acid cation-exchange resins, weak acid cation-exchange resins, strong base anion-exchange resins, and weak base anion-exchange resins will be investigated.

Operation of the bench-scale vessel using virgin resin provided a maximum hardness removal efficiency of 83.3%. Increased removal efficiencies may be possible with a deeper resin bed to allow for additional contact time with the resin. The baseline testing bed achieved a hardness removal efficiency of 73% after regeneration. Operating trials with the dynamic bed ion-exchange process operating in continuous flow mode showed 75% hardness removal efficiency, which was comparable to the hardness removal efficiency achieved in the baseline tests after bed regeneration.

The dynamic bed appeared to consume less regenerant for the same amount of hardness removal compared to resin supplier recommendations but had a higher waste volume. It is expected that hardness removal efficiency, regenerant consumption and waste volume efficiency will be improved with improved test apparatus.

Materials and Methods

Ion-Exchange Resin—Strong acid cation (SAC) exchange resin was supplied in sodium form. The resin manufacturer specification stated the resin had an as-shipped total capacity of 30,000 grains per cubic foot (as CaCO₃). The resin has a size range of 0.35×1.2 mm and as shipped has a nominal weight of 48-55 lbs at approximately 45% moisture. Details relating to the ion-exchange media are published in Culligan International, 1994. Water Conditioning Media Specifications. Cat. No. 01-8811-33.

Regeneration Salt—Sifto Crystal Plus sodium chloride salt was used to regenerate the ion-exchange resin. Regeneration brine was made to a concentration of 130 g/L (11.50%) by dissolving 26 kg of salt in 200 liters of water.

The synthetic test water prepared for hardness removal experiments used tap water to which calcium chloride was added to achieve a total hardness of 2052 mg/I as CaCO₃. The calcium chloride flake (DOWFLAKE™ Xtra) had an average purity of 85%.

Hardness was measured by the drop titration method using a Hach hardness test kit. For samples that exceed the test range, the samples were diluted with deionized water and re-tested. In addition to hardness, samples were tested for conductivity, pH, and temperature.

Data was acquired during three stages of operation. During the first stage, no regenerant solution was included in the cycle to exhaust the resin. For the purpose of this bench-scale pilot study, resin exhaustion was defined as the break-through point where hardness removal efficiency dropped below 10%. During the second stage, regenerant solution was added and no further synthetic hard water was added, and the ability of the regenerated resin to purify the synthetic hard water was confirmed. During the third stage, both synthetic hard water and regenerant solution were added to test water purification with simultaneous regeneration.

Test Apparatus

The bench-scale vessel included a 20 liter plastic container as the equivalent of the body 12 shown in FIG. 1. The bench-scale vessel internals were fabricated from plastic sheet and modified polyvinylchloride fittings. The bench-scale vessel had a diameter of 225 mm and a total side wall height of 300 mm and a lower cone depth of 150 mm. Peristaltic pumps were used for synthetic water feed, brine feed, brine waste, and rinse water waste. A peristaltic pump was originally intended to be used as the resin recirculation pump; however, in early testing it was found that the resin would plug the tubing. Consequently, the peristaltic pump was replaced by an air-lift pump for the resin recycle. This resulted in a recycle rate of approximately 1.5 to 2 liters/min with about 50% resin. The bench-scale vessel was filled with a total of twelve (12) liters of ion-exchange resin. The active resin bed above the inlet distributer was approximately 125 mm (5 inches). A portion of the reactor wall protruded into the reactor in the area of the active resin bed reducing the available area and volume of the resin bed. The total active resin bed area was approximately 275 cm² (42.4 in²) and active bed volume was 3.42 L (0.12 ft³).

During testing, synthetic water was fed to the reactor at flow rates between 190-310 ml/min (3.3-5.4 BV/hr) with an average flow rate of 250 ml/min (4.4 BV/hr).

Stage 1—Resin Exhaustion

During the stage 1, the reactor was operated with no regeneration fluid to exhaust the resin and obtain a treatment baseline. Synthetic water with a hardness of 2050 mg/L as CaCO₃ was fed into the reactor at an average flow rate of 250 ml/min corresponding to 4.4 BV/hr. The resin recycle was operated at a flow rate of 2 liters per minute to ensure the entire resin bed was exhausted. The test was performed until hardness removal efficiency fell below 10%.

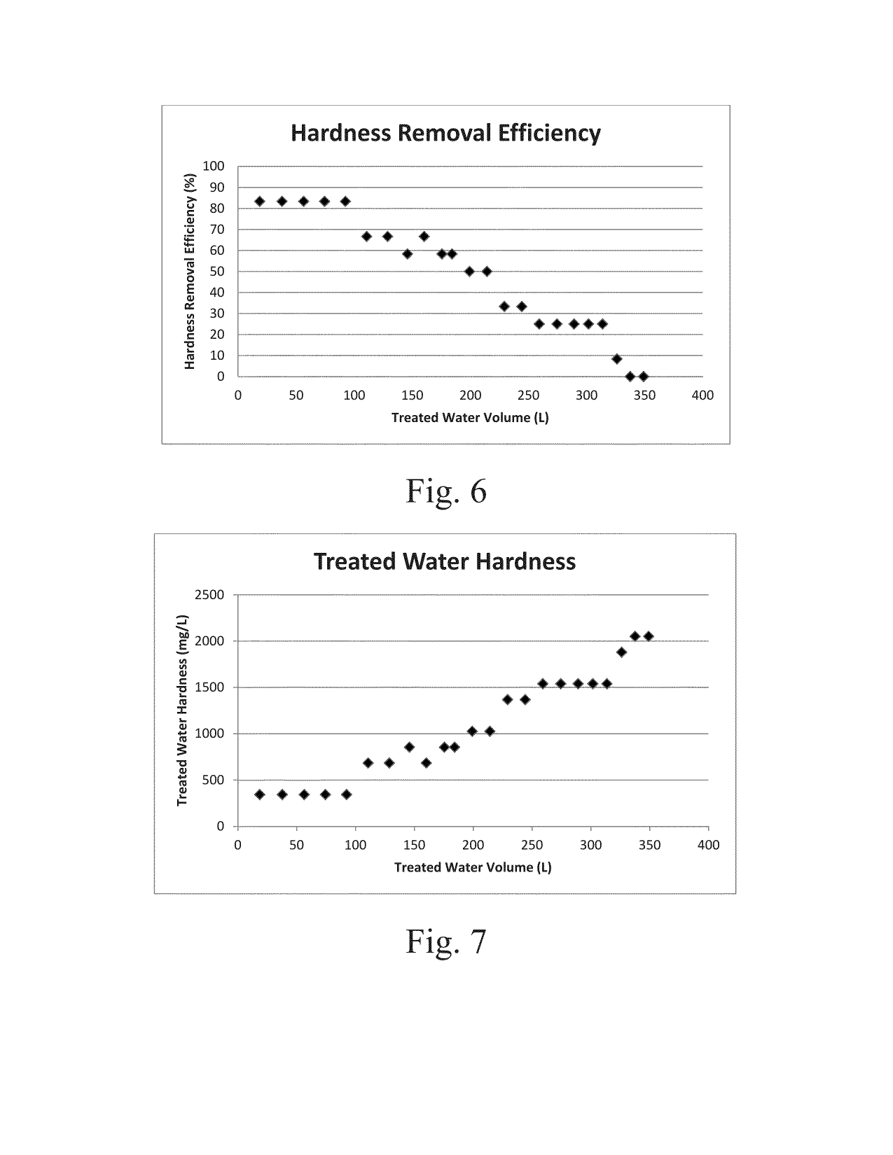

FIGS. 6 and 7 respectively show the hardness removal efficiency and the treated water hardness for the baseline operation. The initial hardness removal trial indicated that with the amount of hardness in the feed water and the selected feed flow rate, only 83.33% of the hardness could be removed with hardness leakage of 342 mg/L. The specified limitation on the testing range of the Hach method required the test samples to be diluted, the accuracy of the Hach titration method is only +/−1 drop or 171 mg/L. The shallowness of the resin bed was likely to have contributed to the hardness leakage. This was not of concern as the intent was only to determine a proof-of-concept for the process and not to optimize performance.

Stage 2—Resin Recycle Bed Regeneration

During the stage 2, regeneration of the ion exchange resin was tested using the resin recycle method. The resin was first exhausted and then regenerated for 1 hour with 11.50% NaCl brine at a flow rate of 79 ml/min while the resin was recycled at 2 L/min. The regeneration was stopped and the bed was flushed with 20 liters of tap water. The bed was then placed back into services and synthetic water, with a hardness of 2050 mg/L as CaCO₃, was fed into the reactor at an average flow rate of 228 ml/min corresponding to 4 BV/hr. The resin recycle was maintained at a flow rate of 1.8 liters per minute.

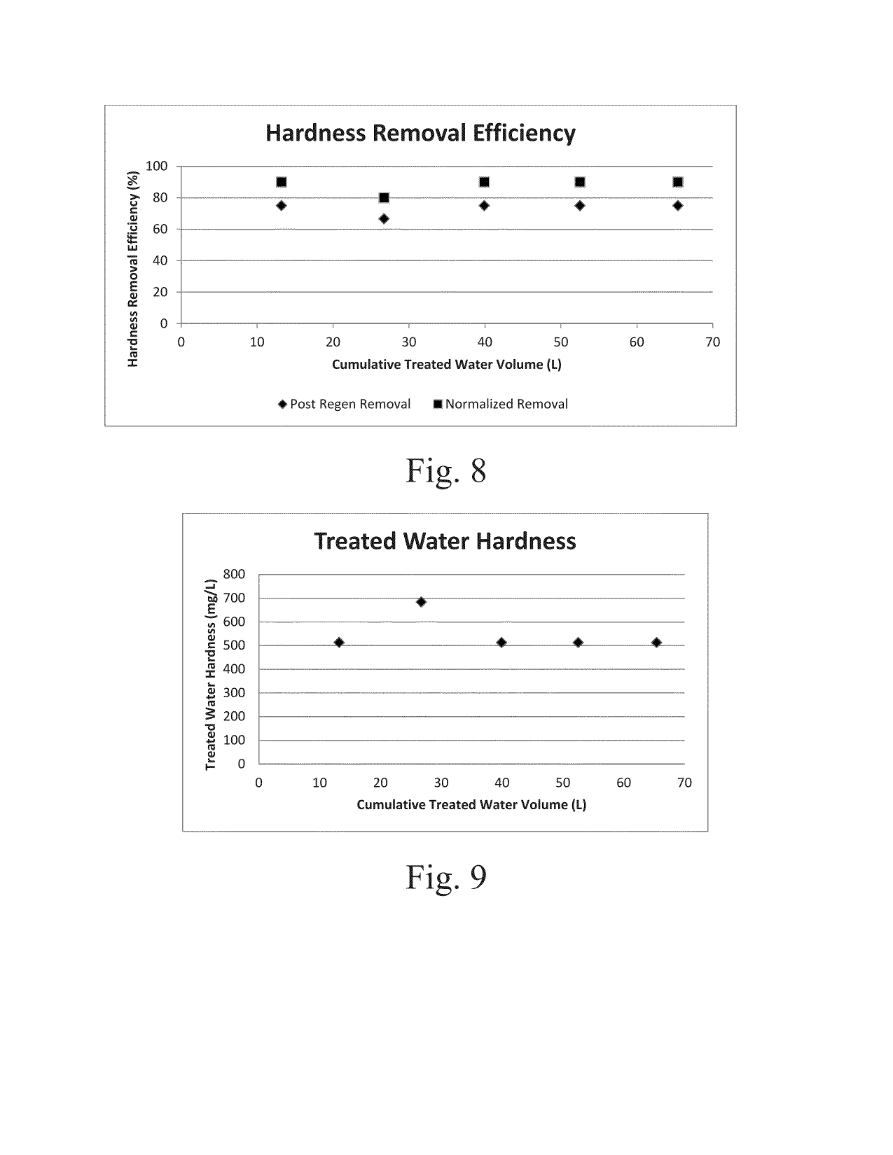

FIGS. 8 and 9 respectively show the hardness removal efficiency and the treated water hardness for the resin bed after regeneration. It can be observed that hardness removal performance after exhaustion and regeneration by resin recycle approached the hardness removal performance of the virgin resin. Hardness leakage after regeneration was maintained at an average of 547 mg/L with 73% of the feed water hardness removed. This corresponds to an average of 88% of the hardness removal of the virgin resin. This rate of removal was maintained for 5 hours or approximately 20 bed volumes before the test was concluded. After regeneration was confirmed, the bed was not run to exhaustion again. The results of the regeneration test indicated that regeneration can be achieved within the bench-scale vessel.

Stage 3—Dynamic Bed Operation

During the stage 3, continuous regeneration of the resin bed during operation was tested.

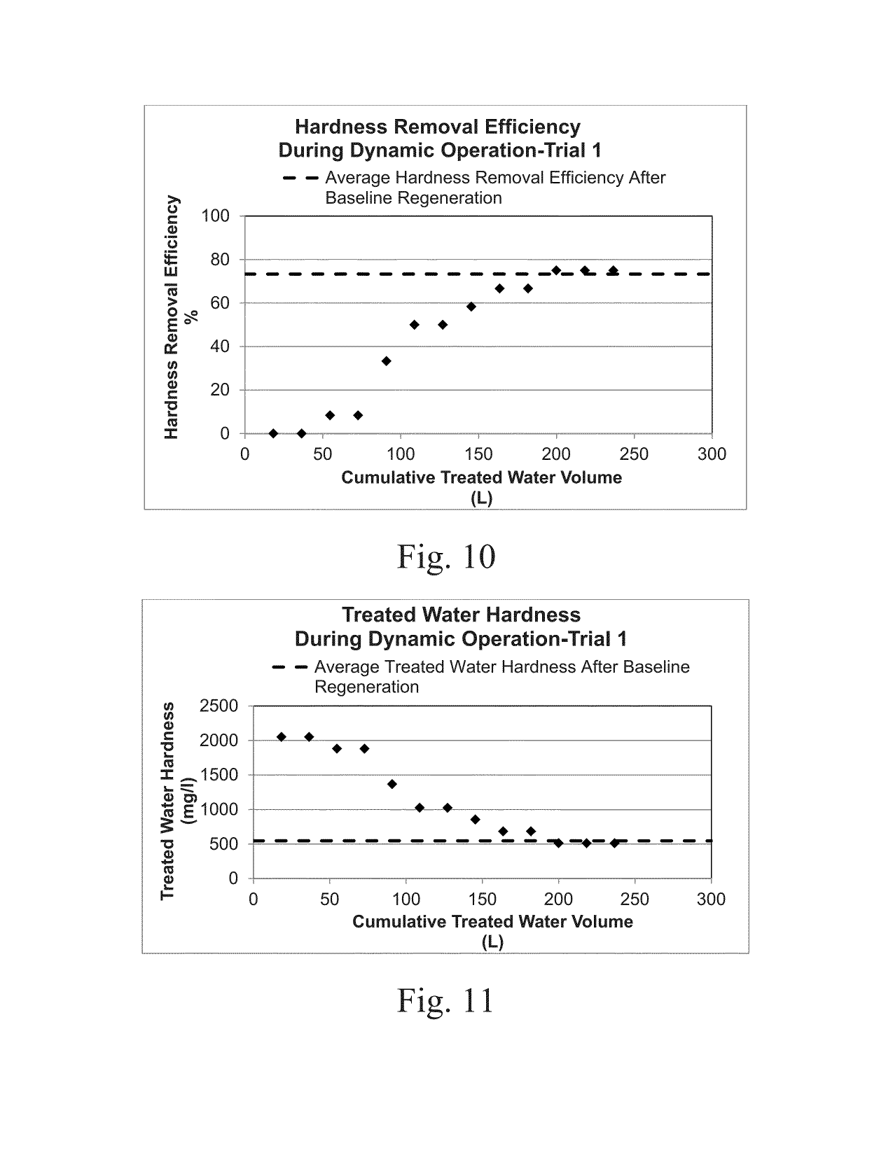

FIGS. 10 and 11 respectively show the hardness removal efficiency and the treated water hardness for Trial 1. Trial 1 involved exhausting the resin bed while using feed water with 2050 mg/I total hardness. Then, the feed water flow was maintained at 300 ml/min and a regenerant solution of 11.50% NaCl brine was fed into the regeneration zone of the reactor at a rate of 12 ml/min. The resin recycle rate was maintained at an average of 1.8 L/min. The waste brine was withdrawn at an average rate of 157.3 ml/min and the rinse waste was withdrawn at an average rate of 13.8 ml/min.

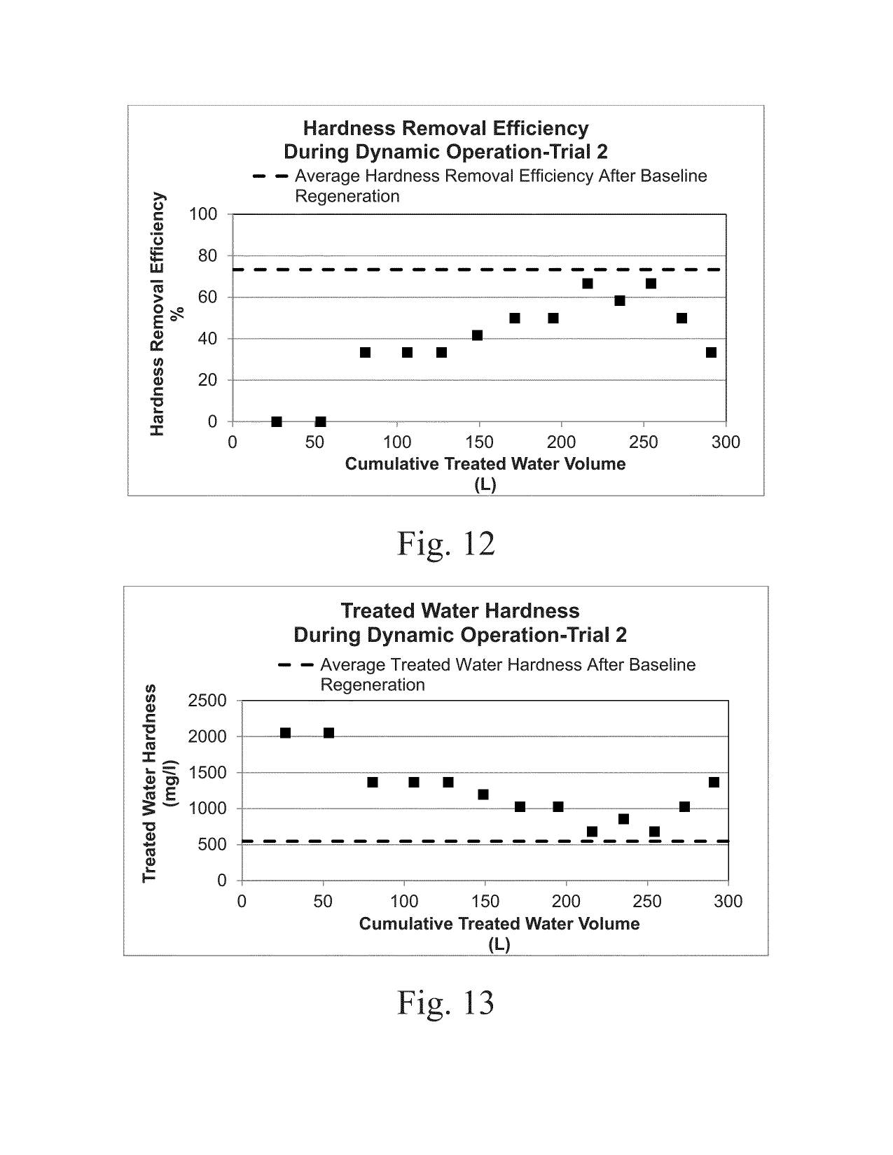

FIGS. 12 and 13 respectively show the hardness removal efficiency and the treated water hardness for Trial 2. Trial 2 was set up to operate the process for a longer duration and test the effect of brine waste volume reduction on the hardness removal efficiency. First the resin bed was again exhausted using feed water with 2050 mg/I total hardness. The feed water flow rate was maintained at 370 ml/min and a regenerant solution of 11.50% NaCl brine was then fed into the regeneration zone of the reactor at a rate of 10 ml/min. The resin recycle rate was maintained at an average of 1.8 L/min. Operation continued until no hardness removal was observed. The waste brine was withdrawn at an average rate of 14 ml/min and the rinse waste was withdrawn at an average rate of 14.3 ml/min.

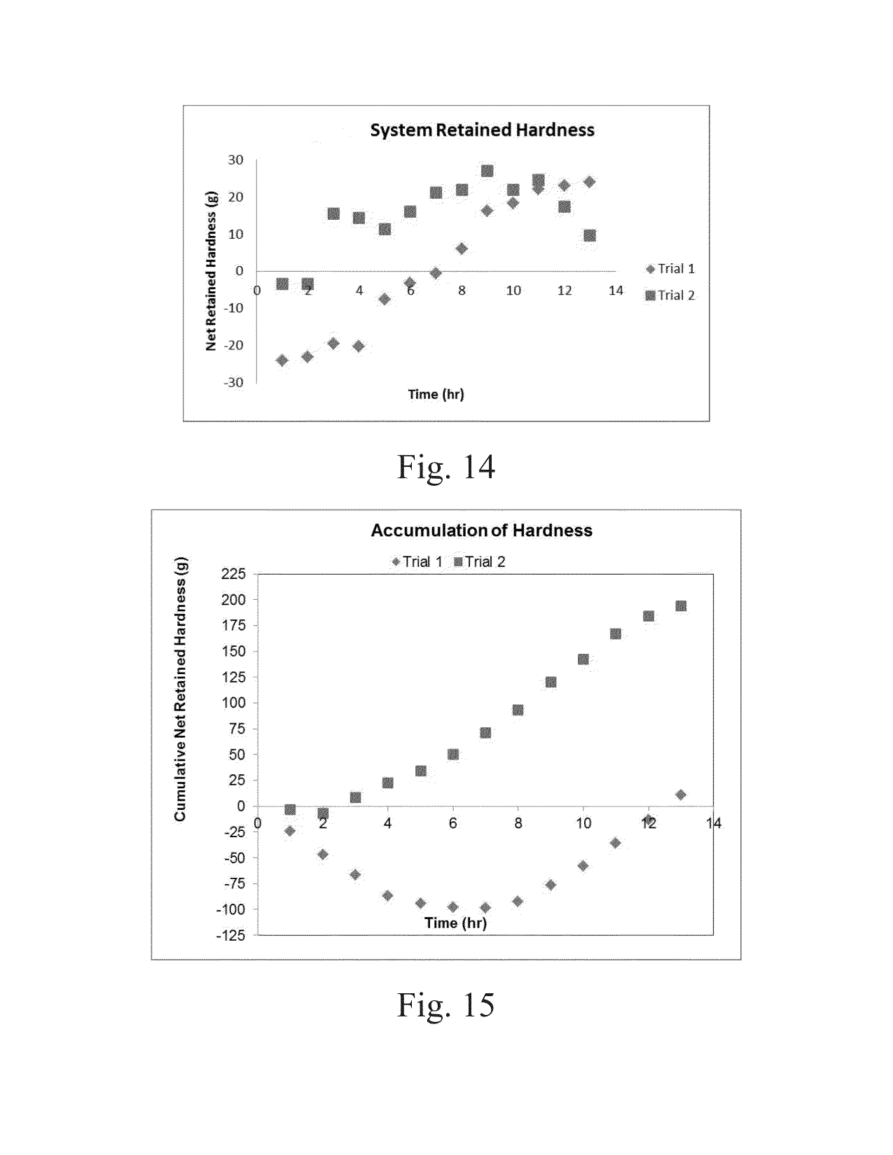

FIG. 14 shows the net retained hardness for Trials 1 and 2.

FIG. 15 shows the cumulative net retained hardness for Trials 1 and 2.

Results from Trial 1 show that the resin within the reactor was slowly being regenerated while the removal efficiency slowly increased until it reached 75% total hardness removal. This is comparable to the average hardness removal efficiency (73%) after initial bed regeneration in the baseline tests. The test provided the basic proof of concept for the dynamic bed ion-exchange process. It demonstrated that the system was capable of providing treatment while continuously regenerating the ion-exchange resin. In addition, results from Trial 1 showed that the dynamic bed ion-exchange process has the potential for achieving a hardness removal efficiency equivalent to the hardness removal efficiency in the baseline test.

During the test the exhausted resin bed was regenerated and an additional 210,000 mg (3250 gr.) of hardness was removed. The total additional hardness removed is equivalent to 38% of an equivalent resin bed with capacity of 20,000 grains/ft³. The total brine consumption was 9.36 L at 130,000 mg/L of salt for a total salt consumption of 1.22 kg or approximately 6.4 pounds of salt per cubic foot of resin. The total brine and rinse waste was 124.8 Liters.

In comparison, the resin supplier recommended regeneration with 2.72 kg (6 lbs) of salt per cubic foot of resin at 10-15% to regenerate to a capacity of 20,000 grains/ft³. For 1.38 regenerations of a 0.42 ft³ resin bed this equates to 1.58 kg. Recommended rinse water is minimum 35 gallons per cubic foot. Using the minimum requirement, the amount of rinse water required for 1.38 regenerations would be 76.7 liters. Total brine and rinse waste would be 88.8 liters.

The results of Trial 2 did not duplicate the results of the Trial 1. The exhausted resin regenerated slowly and although initially the treated water hardness began to drop, the removal efficiency increased slowly and peaked at about 65% and then dropped rapidly. Trial 2 was repeated with the same result. Data analysis and mass balance revealed the observed hardness removal deficiency in both runs of Trial 2. The brine waste flow was decreased from 157.3 ml/min to 14 ml/min in an effort to reduce the total waste from the system and withdraw more concentrated waste brine from the system. The result was an accumulation in hardness within the process reactor over time as the amount of hardness entering the system in the feed water exceeded the amount leaving the system in the waste brine.

During Trial 1, the initial net hardness leaving the system at the beginning of the trial was due to the resin being fully exhausted at the beginning of the trial. The excess hardness was removed via the brine stream while the initial hardness removal from the feed water stream is negligible. As the trial proceeded and the resin was regenerated, the hardness in the brine began to drop and the overall system became more balanced although there is net hardness increasing in the system as the hardness in the waste brine is diluted.

In Trial 2, insufficient removal of waste hardness was observed. There was an initial net removal of hardness from the system. However, the lack of waste brine removal increased the retained hardness. Examination of the waste brine hardness concentration and conductivity in the Trials 1 and 2 showed that the maximum concentrations in the brine waste appeared to be limited. The limiting factor appeared to be the resin recycle rate. The air-lift pump had a minimum discharged rate of approximately 1 liter/min before it stopped operating. This resulted in the resin bed being turned over at a higher rate than the resin exhaustion. This further resulted in excess treated water being drawn down with the resin bed into the regeneration zone and diluting the brine. This required a higher waste brine flow rate to compensate for the dilution. Greater control of the resin recycle rate may facilitate lower waste volumes and mitigation of retained hardness in the system.

### Example II

A dynamic ion exchange pilot scale test unit was manufactured to treat larger water volumes than the bench-scale vessel. The pilot-scale test vessel had the general design of the vessel 310 and a volume of approximately 170 Liters. The performance of the dynamic ion exchange pilot-scale test vessel was evaluated by performing a process-stability test to treat a total feed water volume of about 5000 Liters.

The process-stability test included the media exhaustion mode and the dynamic operation mode. In the media exhaustion mode, the media bed was partially exhausted until hardness removal efficiency reached 80% (at about 2000 Liters of flow through the system). In the dynamic operation stage, regenerant solution was added to the system. The feed water, with 2050 mg/I total hardness, was maintained at 4.20±0.28 L/min during both stages. During the dynamic operation stage, a regenerant solution of 12.50% NaCl brine was fed into the regeneration zone at a constant rate of 0.75 L/min.

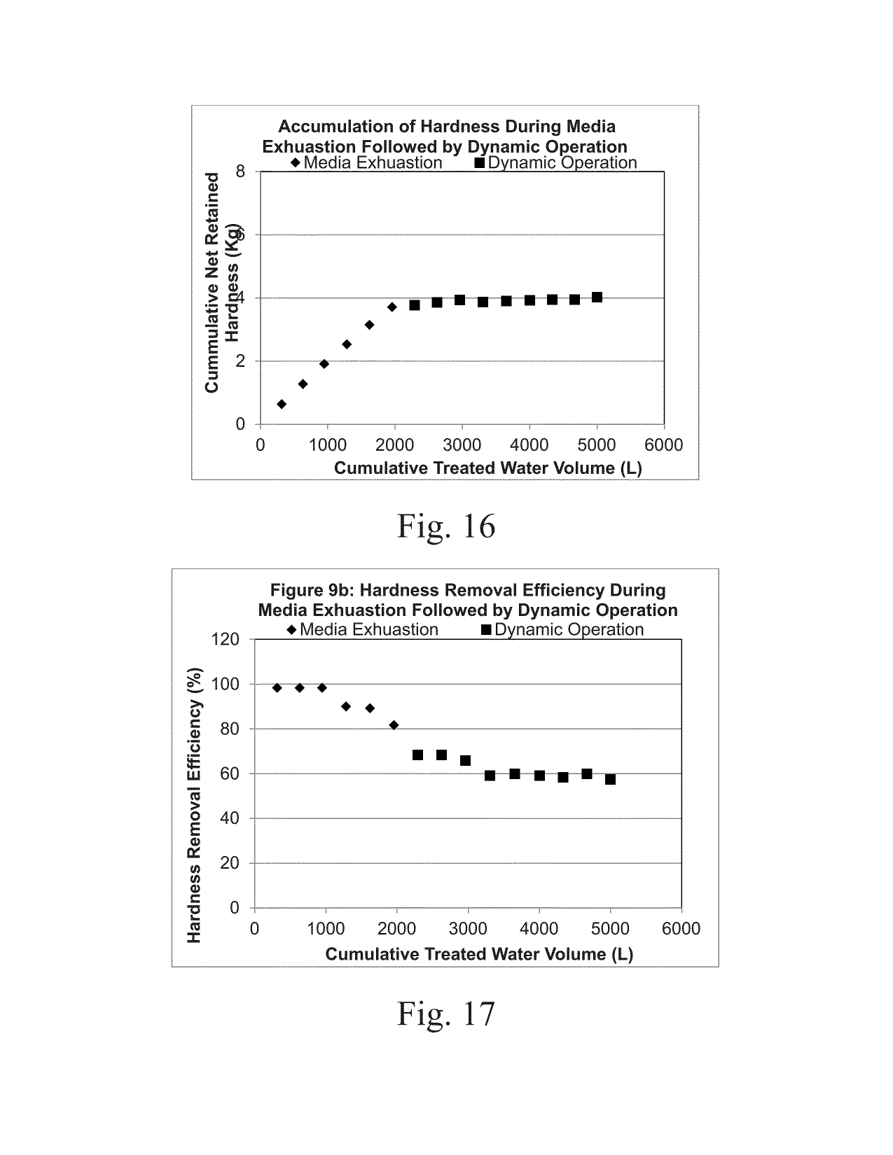

FIGS. 16 and 17 show cumulative net hardness and hardness removal efficiency of the pilot scale test during the process-stability test. Each of FIGS. 16 and 17 shows data during the media exhaustion and dynamic operation phases. During the dynamic operation stage, the cumulative net hardness retained in the unit was maintained at 3.91±0.07 Kg (FIG. 16) and the treated water hardness removal efficiency was maintained at 61.85±4.37% (FIG. 17).

### EXAMPLES ONLY

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. An ion-exchange water purification method comprising:
exposing feed water to active media in a vessel, resulting in treated water and spent media;
flowing the treated water upwards in the vessel and recovering the treated water;
flowing the spent media to a regeneration zone of the vessel below the active media;
exposing the spent media to a regenerant in the regeneration zone, resulting in regenerated media and spent regenerant;
flowing the regenerated media to a point above the active media;
flowing the regenerated media from the point above the active media toward the active media and flowing the treated water in countercurrent from the active media toward the regenerated media, rinsing the regenerated media and resulting in rinsed media and rinse water;
flowing the rinsed media to the active media; and
removing the spent regenerant.

2. The method of claim 1 wherein exposing the feed water to the active media comprises providing the feed water into the vessel at a point below the active media and flowing the feed water upwards in countercurrent through the active media as the spent media flows downwards towards the regeneration zone.

3. The method of claim 1 wherein the point above the active media comprises a separator partially fluidly isolated from the active media and in fluid communication with the active media along a conduit for containing diffusion of the rinsed media and the rinse water into the treated water.

4. The method of claim 3 wherein:
flowing the treated water in countercurrent from the active media toward the regenerated media comprises flowing the treated water upward through the conduit into the separator; and
flowing the regenerated media from the point above the active media toward the active media comprises flowing the regenerated media downward through the conduit from the separator in countercurrent with the treated water flowing upward into the separator for rinsing the regenerated media and resulting in the rinsed media.

5. The method of claim 1 wherein removing the spent regenerant comprises removing the spent regenerant from the regeneration zone.

6. The method of claim 1 further comprising controlling fluid flow between the active media and the regeneration zone for facilitating exposing the feed water to the active media.

7. The method of claim 1 further comprising controlling fluid flow between the regeneration zone and the point above the active media for facilitating exposing the spent media to the regenerant.

8. The method of claim 1 wherein flowing the spent media to the regeneration zone comprises:
flowing the spent media to the a spent media zone located above the regeneration zone; and
flowing the spent media from the spent media zone to the regeneration zone;
wherein fluid flow between the spent media zone and the regeneration zone is restricted to mitigate diffusion of the regenerant from the regeneration zone to the active media.

9. The method of claim 1 wherein flowing the regenerated media to the point above the active media comprises:
flowing the regenerated media from the regeneration zone to a spent regenerant recovery zone of the vessel below the regeneration zone; and
flowing the regenerated media from the spent regenerant recovery zone to the point above the active media.

10. The method of claim 9 wherein removing the spent regenerant comprises removing the spent regenerant from the spent regenerant recovery zone.

11. The method of claim 9 further comprising controlling fluid flow between the regeneration zone and the spent regenerant recovery zone for facilitating exposing the spent media to the regenerant.

12. The method of claim 1 wherein exposing the spent media to the regenerant comprises agitating the spent media, the regenerant, the regenerated media, and the spent regenerant in the regeneration zone.

13. The method of claim 12 wherein agitating the spent media, the regenerant, the regenerated media, and the spent regenerant comprises providing a crosscurrent within the regeneration zone.

14. The method of claim 12 wherein agitating the spent media, the regenerant, the regenerated media, and the spent regenerant comprises mechanically stirring the spent media, the regenerant, the regenerated media, and the spent regenerant in the regeneration zone.

15. The method of claim 1 wherein:
exposing the feed water to the active media in the vessel;
flowing the treated water upwards in the vessel and recovering the treated water;
flowing the spent media to the regeneration zone of the vessel below the active media;
exposing the spent media to the regenerant in the regeneration zone;
flowing the regenerated media to the point above the active media;
flowing the regenerated media from the point above the active media toward the active media and flowing the treated water in countercurrent from the active media toward the regenerated media;
flowing the rinsed media to the active media; and
removing the spent regenerant;
are performed simultaneously.

16. The method of claim 1 wherein:
a media exhaustion phase comprises:
exposing the feed water to the active media in the vessel;
flowing the treated water upwards in the vessel and recovering the treated water;
flowing the spent media to the regeneration zone of the vessel below the active media;
flowing the spent media to the point above the active media; and
flowing the spent media from the point above the active media toward the active media and flowing the treated water in countercurrent from the active media toward the spent media; and
a dynamic operation phase comprises:
exposing the feed water to the active media in the vessel;
flowing the treated water upwards in the vessel and recovering the treated water;
flowing the spent media to the regeneration zone of the vessel below the active media;
exposing the spent media to the regenerant in the regeneration zone;
flowing the regenerated media to the point above the active media;
flowing the regenerated media from the point above the active media toward the active media and flowing the treated water in countercurrent from the active media toward the regenerated media;
flowing the rinsed media to the active media; and
removing the spent regenerant;
no regenerant is added to the regeneration zone during the exhaustion phase; and
the media exhaustion phase is alternated with the dynamic operation phase.

17. An ion-exchange water purification vessel comprising:
a body;
a treatment zone defined within the body for receiving an active media;
a feed water inlet for providing feed water to the treatment zone and exposing the feed water to the active media, resulting in treated water and spent media;
a regeneration zone defined within the body below the treatment zone for receiving the spent media;
a regenerant inlet for providing regenerant to the regeneration zone and exposing the spent media to a regenerant, resulting in regenerated media and spent regenerant;
a regeneration zone barrier positioned between the treatment zone and the regeneration zone for restricting fluid flow between the treatment zone and the regeneration zone; and
a separator above the treatment zone for exposing the regenerated media to the treated water to rinse the regenerated media, resulting in rinsed media and rinse water;
wherein the separator is in fluid communication with the regeneration zone for receiving the regenerated media from the regeneration zone;
the separator is in fluid communication with the treatment zone for receiving purified fluid from the treatment zone; and
the separator is in fluid communication with the treatment zone for providing the rinsed media to the treatment zone for adding to the active media.

18. The vessel of claim 17 wherein the feed water inlet comprises a distributor positioned below the treatment zone for providing the feed water to the treatment zone in countercurrent to a downward flowing moving bed of active media.

19. The vessel of claim 18 further comprising a spent regenerant outlet intermediate the feed water inlet and a bottom end of the vessel.

20. The vessel of claim 19 wherein the separator is in fluid communication with the regeneration zone through a regenerated media outlet proximate the bottom end of the vessel, and the spent regenerant outlet is positioned intermediate the distributor and the regenerated media outlet.

21. The vessel of claim 20 further comprising a spent media barrier positioned in the regeneration zone above the regenerated media outlet for restricting flow of spent media to the spent media outlet to prolong the residence time of the spent media in the regeneration zone.

22. The vessel of claim 17 wherein the separator is in fluid communication with the treatment zone through a conduit extending downward towards the treatment zone for confining the volume within which the regenerated media is exposed to the treated water and mitigating diffusion of the rinse water and of any residual regenerant mixed with the rinse water into the treatment zone.

23. The vessel of claim 17 wherein:
the separator comprises a spent regeneration fluid separation zone in fluid communication with a regenerated media rinsing zone;
the separator is in fluid communication with the regeneration zone at the spent regeneration fluid separation zone; and
the separator is in fluid communication with the treatment zone at the regenerated media rinsing zone.

24. The vessel of claim 17 wherein:
the regeneration zone barrier comprises a first plate and a second plate below the first plate;
the first plate and the second plate define a spent media zone intermediate the first plate and the second plate, and the spent media zone is intermediate the treatment zone and the regeneration zone; and
fluid flow between the spent media zone and the regeneration zone is restricted to mitigate diffusion of the regenerant from the regeneration zone to the active media.

25. The vessel of claim 24 wherein the treatment zone is in fluid communication with the regeneration zone through in the first and second plates for providing a fluid flow path that passes proximate a center of the body and proximate an inside surface of the body.

26. The vessel of claim 25 wherein the first plate slopes downward toward an aperture in the plate along the fluid flow path.

27. The vessel of claim 25 wherein the second plate slopes downward toward an aperture in the plate along the fluid flow path.

28. The vessel of claim 17 further comprising:
a spent regenerant recovery zone barrier below the regeneration zone, the spent regenerant recovery zone barrier defining and separating the regeneration zone from a spent regenerant recovery zone; and
a spent regenerant outlet located in the spent regenerant recovery zone.

29. The vessel of claim 28 wherein the spent regenerant recovery zone barrier comprises a plate having an aperture defined therein for defining a fluid flow path between the regeneration zone and the spent regenerant recovery zone, the plate downwardly tapering towards the aperture in the plate.

30. The vessel of claim 17 wherein the regeneration zone barrier comprises a plate having an aperture defined therein for defining a fluid flow path between the treatment zone and the regeneration zone, the plate downwardly tapering towards the aperture in the plate.

31. The vessel of claim 17 further comprising a mechanical agitator extending into the regeneration zone for agitating fluids within the regeneration zone.

32. The vessel of claim 17 further comprising a hydraulic circulator for providing a cross-current in fluids within the regeneration zone.
